(19) United States
(12) Patent Application Publication
(10) Pub. No.: US 2024/0376272 A1
(43) Pub. Date: Nov. 14, 2024

(54) PROCESS FOR CONTINUOUS EXTRACTION OF LIGNOCELLULOSIC MATERIAL

(71) Applicant: MUSHLABS GMBH, Hamburg (DE)

(72) Inventors: Marc CONRAD, Halle (DE); Irina SMIRNOVA, Hamburg (DE)

(21) Appl. No.: 18/291,918

(22) PCT Filed: Aug. 1, 2022
(86) PCT No.: PCT/EP2022/071526

§ 371 Date: Jan. 24, 2024

(30) Foreign Application Priority Data
Aug. 2, 2021 (DE) 10 2021 120 026.1
Aug. 2, 2021 (LU) LU102852

(51) Int. Cl. C08H 8/00; B01D 11/02

(52) U.S. Cl. CPC C08H 8/00; B01D 11/0284

(57) ABSTRACT

The invention provides a process for continuous extraction of lignocellulosic material, the process comprising at least one stage comprising the steps of a) conveying the lignocellulosic material into an extractor, b) forming, in the extractor, a suspension of the lignocellulosic material and a solvent, c) extracting the lignocellulosic material in the extractor with the solvent, d) withdrawing part of the suspension from the extractor and conveying it to a pressing device at a flow rate \dot{m}4, e) separating the solvent from the lignocellulosic material by pressing off the solvent from the lignocellulosic material in the pressing device and conveying pressed-off solvent as a pressate to a pressate tank at a flow rate \dot{m}7, f) withdrawing pressed lignocellulosic material from the pressing device at a flow rate \dot{m}6, g) returning a first part of the pressate from the pressate tank at a flow rate \dot{m}8 into the extractor, h) withdrawing a second part of the pressate as an extract from the pressate tank at a flow rate \dot{m}9, i) Adding solvent to the lignocellulosic material in any one or more of steps a, b, c, d, e or g at a flow rate \dot{m}2.

The invention relates to a process for continuous extraction of lignocellulosic material.

In view of the depletion of fossil fuel reserves and the need for more sustainable raw material extraction, the use of renewable resources, especially biological raw materials like lignocellulosic biomass, is becoming more and more important. The term “biorefinery” is often used for processes and systems for the exploitation of biological material for the production of biofuels and a wide range of other chemicals in order to substitute oil-based products by biobased products, for example.

Processes for the extraction of lignocellulosic material are known from the prior art (see, for example, WO 2012/110231 A1, WO 2018/114905 A1, U.S. Pat. Nos. 8,822,657 A, 8,772,427 A, 9,624,449 A, EP 2862890 A1; EP 2520608 A1, A. Patel and A. R. Shah, Integrated lignocellulosic biorefinery: Gateway for production of second-generation ethanol and value-added products, Journal of Bioresources and Bioproducts, doi:10.1016/j.jobab.2021.02.001). There is still a need, however, for an efficient, cost-effective and flexible process for extracting valuable substances or impurities from lignocellulosic materials. It is thus an object of the invention to provide such a process.

In one aspect the invention relates to a process for continuous extraction of lignocellulosic material, the process comprising at least one stage comprising the steps of
a) conveying the lignocellulosic material into an extractor,
b) forming, in the extractor, a suspension of the lignocellulosic material and a solvent,
c) extracting the lignocellulosic material in the extractor with the solvent,
d) withdrawing part of the suspension from the extractor and conveying it to a pressing device at a flow rate \dot{m}₄,
e) separating the solvent from the lignocellulosic material by pressing off the solvent from the lignocellulosic material in the pressing device and conveying pressed-off solvent as a pressate to a pressate tank at a flow rate \dot{m}₇,
f) withdrawing pressed lignocellulosic material from the pressing device at a flow rate \dot{m}₆,
g) returning a first part of the pressate from the pressate tank at a flow rate \dot{m}₈ into the extractor,
h) withdrawing a second part of the pressate as an extract from the pressate tank at a flow rate \dot{m}₉,
i) Adding solvent to the lignocellulosic material in any one or more of steps a, b, c, d, e or g at a flow rate \dot{m}₁₂.

The invention provides an efficient, cost-effective and flexible process for the extraction of lignocellulosic material. The process of the invention can be designed as a single-stage process or a multi-stage process, the latter being preferred. I an embodiment where the process of the invention is a multi-stage process the process is preferably configured as a continuous countercurrent process.

In the process of the invention lignocellulosic material is conveyed into an extractor, for example by means of a conveyor or by gravity. Solvent, e.g., water, may be added to the lignocellulosic material on its way to the extractor, for example by sprinkling solvent onto the lignocellulosic material on a conveyor. Alternatively, or additionally, the solvent may, for example, be directly added to the extractor. The amount of solvent continuously added is intended to counterbalance any liquid phase withdrawn, e.g., as an extract, from the process on a net basis, i.e., any difference in the mass flow of liquid phase entering and leaving the process stage or, in particular in a multi-stage process, the whole process or system. The solvent added may be fresh solvent, in particular in case of a single-stage process. In a multi-stage process the solvent may be pressate generated in a subsequent stage or fresh solvent, the latter being preferably used in the final stage. In the extractor, in which a sufficient amount of solvent is preferably already present, a suspension of the lignocellulosic material and the solvent is formed. The extractor may, for example, be equipped with an agitator in order to promote the formation of a suspension and the extraction of substances from the lignocellulosic material, in particular from the water absorbed in the moist lignocellulosic material. In the extractor, the lignocellulosic material is extracted with the solvent.

A part of the suspension of the lignocellulosic material and the solvent is continuously withdrawn from the extractor and conveyed to a pressing device, for example, by means of a suitable pump (e.g., a rotary pump, lobe pump or progressive cavity pump). The pressing device is preferably a screw separator. In the pressing device, the solvent is separated from the lignocellulosic material by pressing off the solvent from the lignocellulosic material. Pressed-off solvent (pressate) is conveyed to a pressate tank, e.g., by means of a suitable pump (e.g., piston pump, centrifugal pump). Pressed lignocellulosic material is withdrawn from the pressing device. A first part of the pressate is returned into the extractor, a second part of the pressate is withdrawn as an extract from the pressate tank and can either be removed from the process for further processing or fed back into the process by adding it, for example, to the lignocellulosic material when fed into the extractor or by adding it directly into the extractor containing a suspension of the lignocellulosic material and solvent. The first part of the pressate returned into the extractor can be returned by gravity, i.e., by placing the pressate tank higher than the extractor, and/or by using one or more pumps.

The term “lignocellulosic material” refers to biological material, e.g., plant material, containing lignocellulose. Lignocellulosic material contains lignocellulose, which is composed of the carbohydrate polymers cellulose and hemicellulose, and lignin, an aromatic polymer. The term encompasses, for example, plant material like straw, e.g., rice and grain straw, sugar cane bagasse, corn stover etc. The terms “lignocellulose containing material”, “lignocellulosic biomass” or “lignocellulose” may be synonymously used for the term “lignocellulosic material”. The term “lignocellulosic material” as used herein encompasses, for example, fresh lignocellulosic material, i.e., lignocellulosic material that has not yet been extracted, at least not yet extracted with a process of the invention, and pressed lignocellulosic material. The term “pressed lignocellulosic material” relates to lignocellulosic material from which liquid phase has been pressed off, e.g., my means of a screw press. The term is not to be construed as meaning that the lignocellulosic material has to be in a compressed state or completely free of any liquid phase bound by it after the pressing process.

The term “hydrothermally pretreated lignocellulosic material” refers to lignocellulosic material that has been hydrothermally treated. Hydrothermal pretreatment means the application of hot water or steam at temperatures of >100° C., for example, 150-300° C. to lignocellulosic material (see, for example, Ahmed B, Aboudi K, Tyagi V K, Alvarez-Gallego C J, Fernández-Güelfo L A, Romero-Garcia L I, Kazmi A A, Improvement of Anaerobic Digestion of Lignocellulosic Biomass by Hydrothermal Pretreatment, Applied Sciences. 2019; 9(18):3853, doi:10.3390/app9183853). A preferred temperature range for the hydrothermal pretreatment is 150-250° C. or 150-230° C. The term encompasses a dilute acid pretreatment (DAP), e.g., with dilute sulfuric acid, nitric acid, phosphoric acid or hydrochloric acid, and alkaline pretreatment, i.e., the use of alkaline solutions such as solutions of NaOH, KOH, Ca(OH)₂ or ammonia. Further, the term encompasses the term “autohydrolysis”, relating to a hydrothermal treatment with only water. The term “autohydrolytically pretreated lignocellulosic material” relates to lignocellulosic material treated by autohydrolysis. “Hydrothermally pretreated lignocellulosic material” may also be referred to as “steam pretreated biomass” (SPB). The term “hydrothermal pretreatment” should not be construed as including any subsequent enzymatic hydrolysis.

The term “extraction” as used herein relates to a solid-liquid extraction, and encompasses the terms “leaching”, wherein the solute to be extracted from lignocellulosic material is a component of interest, for example a valuable substance, and “washing”, wherein the solute to be extracted from lignocellulosic material is an extraneous material, impurity or contaminant, i.e., an unwanted component that shall be removed from the lignocellulosic material. Examples of valuable substances to be extracted from lignocellulosic material are xylan oligomers, xylose, arabinose, acetic acid, furfural, and hydroxymethylfurfural (HMF). Examples of unwanted components to be washed from lignocellulosic material are mineral components (“ash”), fine particles (minerals, lignin-rich particles, microorganisms), dust or manure. Any unwanted solute may be collectively referred to as “contaminant” in this application.

The term “solvent” as used herein relates to a liquid phase used to extract material from lignocellulosic material, and encompasses the terms “pressate” and “extract”, and relates to both fresh solvent, i.e., a solvent not yet containing substances extracted from the lignocellulosic material, and a solvent containing or enriched with substances extracted from the lignocellulosic material. The term “pressate” relates to solvent being pressed-off from a suspension composed of lignocellulosic material and solvent, and thus containing substances extracted from the lignocellulosic material. The term “extract” used as a noun in the context of the present invention refers to the second part of pressate withdrawn from the pressate tank at a flow rate \dot{m}₉, that is a portion of pressate that is a) withdrawn from the process, i.e. a portion of the solvent sufficiently enriched in extracted substances that it can finally be removed from the process, e.g. for a further processing like the isolation of components, or b) withdrawn from the pressate tank and added to fresh lignocellulosic material when conveyed to the extractor or is directly added to the extractor. The term “extractant” may also be used interchangeably for “solvent”. The term “fresh solvent” as used herein refers to solvent, e.g., water, that is free or essentially free from any of the substances that are to be extracted from the lignocellulosic material.

The term “raffinate” refers to liquid phase still bound to pressed lignocellulosic material, i.e., the moisture content of the pressed lignocellulosic material leaving the pressing device. Unless stated otherwise or implicit from the context, the terms “extracted lignocellulosic material” or “extracted biomass” relate to lignocellulosic material that has undergone an extraction process according to the invention. The term “pressed lignocellulosic material” (see above) is used herein in relation to lignocellulosic material comprising the solid phase and raffinate.

The term “conveyed” in relation to, for example, lignocellulosic material, solvent, or pressate, relates to any transport of the material from one place to another, be it via a pump, conveyor belt, screw conveyor, by gravity or by other means.

A term like “withdrawing x from y” as used herein in relation to, for example, part of the suspension, pressed lignocellulosic material or part of the pressate as “x”, means that x is taken or separated from y, e.g., part of the suspension is taken from the extractor (separated from the suspension in the separator).

The term “countercurrent” in relation to the process of the invention refers to the opposite flow of lignocellulosic material to be extracted or a suspension of lignocellulosic material and solvent and the solvent used for extraction of the lignocellulosic material.

The term “multi-stage process” relates to a process comprising at least two stages, for example two, three, four, five, six or more stages.

The term “screw separator” (also “screw press separator”, “screw compactor”, “screw press”) refers to a device for solid-liquid separations comprising a rotating auger transporting and pressing the suspension in the direction of a solid outlet, and a screen through which the liquid phase can be separated from the solid phase. The solid outlet may comprise a hydraulic piston for controlling pressure.

The term “extractor” refers to an apparatus used to extract substances from a material, i.e., remove the substances from the material and transfer them to a solvent, e.g., valuable substances or contaminants from a lignocellulosic material. An example of an extractor is a vessel equipped with means for agitating a material suspended in a solvent.

Unless clearly stated otherwise flow rates are given as mass flow rates (m, kg/s), not volumetric flow rates.

The process according to the invention combines (preferably repeated) suspension extraction and pressing. The first leads to a high mass transport speed, the latter has the advantage that the raffinate flow is very low in relation to the solids flow, i.e., the flow of the starting lignocellulose material. As a result, fewer steps and less solvent are required, despite a high extraction yield, i.e., yield of solute in the final extract. It is an advantage of the process of the invention that the material transport of the valuable substances or contaminants within the lignocellulosic material into the bulk phase of the solvent does not exclusively result from diffusion and mass transfer, as in the case in conventional extractors. Rather, a very fast convective material transport takes place when the solvent is pressed-off by the pressing device from the lignocellulosic material in the suspension. The lignocellulosic material is compressed and solvent is actively pressed-off from the lignocellulosic material together with the valuable substances or contaminants as a pressate. This material transport is brought about by externally applied forces and is therefore convective and faster than the diffusion of valuable substances from inside the lignocellulosic material. Depending on the lignocellulosic material used a further convective material transport may take place when the lignocellulosic material is mixed with solvent. This is especially the case where the cellular structure of the lignocellulosic material used is largely maintained. In such a case, solvent diffuses into the lignocellulosic material and initiates swelling.

In a preferred embodiment of the process of the invention the flow rate \dot{m}₄ with which the suspension is conveyed to the pressing device in step d is greater than the sum of the flow rate \dot{m}₇ with which pressate is conveyed to the pressate tank and the flow rate \dot{m}₆ with which pressed lignocellulosic material is withdrawn from the pressing device. In this embodiment, excess suspension conveyed from the extractor to the pressing device, i.e., a part of the suspension fed into the pressing device but not withdrawn as either pressate or pressed lignocellulosic material, is returned from the pressing device to the extractor at a flow rate \dot{m}₅. This is preferably done by gravity, e.g., by placing the pressing device higher than the extractor. However, this can also be implemented by using at least one suitable pump pumping part of the suspension back into the extractor. Such a reflow of suspension from the pressing device to the extractor facilitates a steady operation of the pressing device.

The flow rate \dot{m}₂ of added solvent is preferably chosen to allow for efficient extraction of solutes in the liquid phase (moisture content) of the lignocellulosic material fed into the process, and is preferably chosen to be as small as possible in order to use as little solvent as possible to extract the solutes. Further preferred, it is chosen to compensate for any removal or loss of liquid phase during the continuous process, be it a one-stage or a multi-stage process, and not otherwise compensated for, e.g., by liquid phase contained in the lignocellulosic material fed into or withdrawn from the system. Separated liquid phase, i.e., “free” liquid phase not bound to the solids of lignocellulosic material, is mainly removed from the process as extract. The flow rate \dot{m}₂ of added solvent may differ from the flow rate \dot{m}₉ of the pressate withdrawn from the process as an extract. This can, for example, in particular be the case where the moisture content of the lignocellulosic material entering the stage is different from the moisture content of the lignocellulosic material leaving the stage. This may, for example, be the case in a single stage process where the moisture content of the lignocellulosic material entering the stage is e.g., determined by any previous pretreatment of the lignocellulosic material, and where the moisture content of the lignocellulosic material leaving the stage is determined by the pressing parameter.

In a preferred embodiment of the process of the invention, the flow rate \dot{m}₂ of added solvent is essentially equal to the flow rate \dot{m}₉ of the pressate withdrawn as an extract. In a multi-stage process of the invention, this applies preferably to at least one of the stages, optionally except for the first stage or the first and the final stage.

The lignocellulosic material may, in step a, be conveyed into the extractor by any suitable means. The lignocellulosic material may, for example, be conveyed into the extractor by gravity, for example using a chute or funnel. This embodiment is advantageous in that it dispenses with the use of auxiliary energy, i.e., active machine support, for actively feeding the lignocellulosic material into the extractor, and may particularly useful for smaller plants.

In another preferred embodiment of the process according to the invention, the lignocellulosic material is, in step a, conveyed into the extractor by means of a conveyor. This facilitates the application of solvent to the lignocellulosic material before it gets into the extractor. The conveyor may, for example, be a conveyor belt or screw conveyor. In a preferred embodiment of the process according to the invention the solvent is added to the lignocellulosic material in step a when conveyed into the extractor. Additionally, or alternatively, the solvent can be added in another suitable process step. It can, for example, be directly added into the extractor in one of steps b or c. The addition of solvent, in particular fresh solvent, to the lignocellulosic material before it is fed into the extractor is particularly useful for quickly achieving a concentration equilibrium between solute in the liquid phase bound within the lignocellulosic material and the bulk phase of the solvent, thereby assisting a rapid and homogeneous distribution of solutes in the bulk phase of the solvent in the extractor.

In a further preferred embodiment of the process of the invention, more pressate is returned to the extractor as is removed as an extract. The flow rate \dot{m}₈ of pressate returned to the extractor is thus preferably greater than the flow rate \dot{m}₉ of pressate withdrawn as an extract.

The pressing device can be any device being able to separate, preferably continuously separate, lignocellulosic material from a solvent, for example a twin-roll press, belt filter press or screw separator, the latter being preferred.

The extractor is preferably an agitator vessel, such that the suspension can be suitably agitated, e.g., stirred, in the extractor. This promotes the mass transport of solutes from the lignocellulosic material into the solvent, in particular with a suspension having a comparatively low solid content. In conventional processes such as displacement washing (pulp washing) or percolation, there is only a comparatively slow transport of substances from the lignocellulosic material surface into the bulk phase of the extract, because the fluid phase flows slowly past the lignocellulosic material due to free convection or a small pressure difference, and because of particle-particle contacts, dead zones and stagnation points, at which the relative speed of particles and fluid is zero and the material transport is limited by diffusion. It is preferred that the solid content of the suspension is below 40% by weight, based on the total weight of the suspension, further preferred ≤35 wt %, ≤30 wt %, ≤25 wt %, ≤20 wt %, ≤15 wt %, or ≤10 wt %, for example in a range of 0.5-15 wt %, 1-12 wt % or 2-8 wt %.

In a preferred embodiment, the solvent is water. The water preferably has a temperature of 20-95° C. For leaching purposes, it is especially preferred to use hot water of a temperature of about 40-95° C., preferably 55-80° C., e.g., 60, 65 or 70° C. For washing purposes, the solvent is preferably water of a temperature of about 20-95° C. It is to be noted here that the solvent may be, for example, process water, i.e., water already containing substances solved therein.

In a further preferred embodiment of the process of the invention the lignocellulosic material is in the form of particles, e.g., wheat straw particles. The lignocellulosic material can be reduced in size by mechanical means, and e.g., crushed, cut or milled into particles using suitable means. The particle size may vary, but is preferably configured to be in a range to facilitate the transport and suspension of the lignocellulosic material and to enlarge the surface area that comes into contact with the solvent. The particle size may depend on the lignocellulosic material used, and will preferably be <20 cm, preferably in a range of 0.5 to 10 cm, further preferred 0.5-5 cm or 0.5-3 cm, especially preferred 0.5 to 2 cm.

The lignocellulosic material can be any lignocellulosic material, and can also be lignocellulosic material that has been pretreated with any pretreatment process suitable for lignocellulosic material. In a particularly preferred embodiment of the process of the invention the lignocellulosic material is a hydrothermally pretreated lignocellulosic material, that is lignocellulosic material pretreated with hot water or steam. Particularly preferred, the lignocellulosic material is autohydrolytically pretreated. Hydrothermal pretreatment results in a breakdown of the lignocellulosic biomass and solubilization of components, and facilitates extraction of valuable substances from the lignocellulosic material. Further, due to its sponge-like structure, hydrothermally pretreated lignocellulosic material that has previously being compacted, e.g., via pressing, swells when it is contacted with solvent, and can also be compressed to a much smaller size. When mixed with solvent, previously pressed pretreated lignocellulosic material swells and more solvent flows into the material, resulting in a convective transport of substances into the solvent.

The hydrothermal pretreatment may be a two-step autohydrolysis pretreatment as described in the literature (see Conrad, M., Haring, H. & Smirnova, I. Design of an industrial autohydrolysis pretreatment plant for annual lignocellulose, Biomass Conv. Bioref. (2019), doi:10.1007/s13399-019-00479-1; Ruiz, H. A., Conrad, M., Sun, S., Sanchez, A., Rocha, G., Romani, A., Castro, E., Torres, A., Rodriguez-Jasso, R. M., Andrade, L. P., Smirnova, I., Sun, R., & Meyer, A. (2019), Engineering aspects of hydrothermal pretreatment: From batch to continuous operation, scale-up and pilot reactor under biorefinery concept, Bioresource technology, 122685, doi: 10.1016/j.biortech.2019.122685; Conrad, M. and Smirnova, I. (2020), Two-Step Autohydrolysis Pretreatment: Towards High Selective Full Fractionation of Wheat Straw, Chemie Ingenieur Technik, 92: 1723-1732,doi:10.1002/cite.202000056). A two-step autohydrolysis pretreatment may comprise the use of screw conveyor reactors (SCRs, see Ruiz et al. 2019 above). A screw conveyor reactor (SCR) is a sealed pressure-tight device comprising at least one reactor vessel, e.g., a horizontal cylindrical vessel, with a rotating auger (screw) transporting solid material like lignocellulosic material or other moist biomass, wherein the material in the vessel can be exposed to hot water or steam under pressure. A screw conveyor reactor (SCR) preferably also comprises a high-pressure screw feeder (HP screw) which can provide for a strong drainage of the lignocellulosic material (see Ruiz et al. 2019, above).

In a further preferred embodiment of the process of the invention, the extraction of the lignocellulosic material is interposed between the two steps of a two-step hydrothermal pretreatment, e.g., autohydrolysis pretreatment. In this embodiment, the lignocellulosic material is hydrothermally pretreated before step a), i.e., before the lignocellulosic material is conveyed to the extractor, and after it has been withdrawn from the pressing device. The process of the invention may additionally be performed before the first hydrothermal treatment step and/or after the second hydrothermal treatment step. Hydrothermal pretreatment can, inter alia, serve to enrich the liquid phase (raffinate) of the lignocellulosic material with solutes. In the process according to the invention, any up- or downstream flow of a fluid, suspension (slurry) or solid is preferably arranged in a manner that, where possible and reasonable, the mass flow occurs by gravity. It is however, also possible to use pumps or other means.

The process of the invention can be designed as a cocurrent process, e.g., a one-stage process. However, in a particularly preferred embodiment of the process of the invention the process is a multi-stage process, especially preferred a countercurrent multi-stage process, comprising at least two stages, a final stage and a stage upstream of the final stage. The final stage comprises the steps a to i above. The at least one upstream stage comprises the steps a to h above and a step i of adding solvent to the lignocellulosic material in any one or more of steps a, b, c, d, e or g at a flow rate \dot{m}₉. In this embodiment, the solvent added to the lignocellulosic material in any one or more of steps a, b, c, d, e or g of the final stage at a flow rate \dot{m}₂ is preferably fresh solvent, whereas the solvent added to the lignocellulosic material in any one or more of steps a, b, c, d, e or g of the at least one upstream stage comprises or consists of the second part of the pressate from the pressate tank. In this embodiment, part of the pressate, i.e., solvent already containing substances extracted from the lignocellulosic material, is reused as a solvent in an upstream stage in order to extract substances from lignocellulosic material fed into that upstream stage, in case of a two-step process from fresh lignocellulosic material, i.e., lignocellulosic material that has not yet undergone an extraction.

In a multi-stage process according to the invention comprising more than two stages, it is preferred that in any of the upstream stages, i.e., the stages upstream from the final stage, including the first stage, the solvent added to the lignocellulosic material in any one or more of steps a, b, c, d, e or g of a stage consists of the second part of the pressate from the pressate tank of the stage directly downstream of said stage.

In a still further preferred embodiment of the process of the invention, the processes comprises at least three stages, namely a first stage, a final stage and one or more intermediate stages between the first and final stage, wherein, in any of the intermediate stages the solvent added to the lignocellulosic material in any one or more of steps a, b, c, d, e or g at a flow rate \dot{m}₁₉ consists of the second part of the pressate withdrawn from the pressate tank in step h) of the following stage, and the lignocellulosic material conveyed into the extractor consists of the pressed lignocellulosic material, the pressed lignocellulosic material comprising the solid phase and the raffinate, i.e. the liquid phase bound to the solid phase, withdrawn from the pressing device in step f) of the previous stage. In this embodiment it is particularly preferred to configure the process as a countercurrent process. As an example, a three-stage process of this embodiment of the process of the invention would comprise a first stage, an intermediate (second) stage and a final stage, the term “first” referring to the stage in which fresh lignocellulosic material is extracted, and the term “final” referring to the stage at the end of which the extracted lignocellulosic material is finally withdrawn from the process. “Countercurrent” means in this context that the lignocellulosic material is conveyed in the direction from the first stage to the final stage, and is gradually extracted from stage to stage, whereas the solvent is conveyed in the opposite direction, i.e., from the final stage to the first stage, whereby it is further enriched with solutes from stage to stage.

In this embodiment, in the first stage, lignocellulosic material, preferably fresh, i.e., not yet extracted, lignocellulosic material, further preferred hydrothermally pretreated lignocellulosic material, especially preferred in the form of particles, e.g., grain straw particles, is conveyed into an extractor, for example a stirred agitation vessel, for example by means of a conveyor, e.g., a belt or screw conveyer. Solvent may, for example, be added to the lignocellulosic material on its way to the extractor on the conveyer, e.g., by spraying the solvent onto the lignocellulosic material, and/or directly to the extractor. In this embodiment, the added solvent is pressate taken from the pressate tank of the following, i.e., the second stage of the process, not fresh solvent. In the extractor, a suspension is formed of the lignocellulosic material and the solvent. It should be noted that the liquid phase in the extractor may comprise solvent already provided in the extractor and the solvent added. The lignocellulosic material is extracted in the extractor with the solvent. In this step the suspension is preferably agitated in a suitable manner, e.g., by stirring, in order to promote extraction of, for example, valuable substances, for example valuable substances solved in the water bound within the lignocellulosic material, or wash out contaminants. Part of the suspension is continuously withdrawn from the extractor and conveyed to the pressing device, for example a screw press, at a flow rate \dot{m}₄, e.g., by means of a suitable pump. In the pressing device the solvent is separated from the lignocellulosic material by pressing off the solvent from the lignocellulosic material. The term “pressing off the solvent” may also encompass removal of moisture originally present in the lignocellulosic material used as starting material, and is not to be construed as meaning that the solvent is completely separated from the lignocellulosic material such that a liquid phase and a dry solid phase free from any liquid phase results. Pressed-off solvent is conveyed, e.g., pumped, as a pressate to a pressate tank at a flow rate my, the pressed lignocellulosic material is withdrawn from the pressing device at a flow rate \dot{m}₆, and conveyed to the next (second) stage to serve as a starting material there. A first part of the pressate from the pressate tank is returned to the extractor at a flow rate \dot{m}₈, and a second part of the pressate is withdrawn as an extract from the pressate tank at a flow rate \dot{m}₉, the flow rate \dot{m}₈ preferably being greater than the flow rate \dot{m}₉. In this embodiment the second part of the pressate is removed from the process as an extract enriched in valuable substances or contaminants extracted from the lignocellulosic material. The extract may be subjected to further processing, e.g., enrichment or isolation processes. As mentioned above, pressate is taken from the following (second) stage of the process of the invention and added to the lignocellulosic material in a suitable process step of the first stage, for example when conveyed to the extractor and/or directly into the extractor in the first stage at a flow rate \dot{m}₉.

In this embodiment, pressed lignocellulosic material withdrawn from the pressing device in the first stage of the process of the invention is treated in a second stage in the same manner as described for the first stage. The steps described above are carried out again with the lignocellulosic material taken from the pressing device of the first stage. The main difference is that the second part of the pressate taken from the pressate tank in the second stage is not withdrawn from the process but reused in the first stage, i.e., added to the lignocellulosic material being the starting material in the first stage. The solvent added in the second stage to the lignocellulosic material consists of pressate withdrawn from the following (final) stage. In case of more than one intermediate stage (e.g., a four-stage, five-stage or six-stage process) pressate from any given intermediate stage is withdrawn to be added to lignocellulosic material treated as starting material in the previous stage, and pressed lignocellulosic material withdrawn from the pressing device enters the subsequent stage as a starting material for the next round of extraction.

In the final stage of this embodiment of a multi-stage process of the invention the second part of the pressate is also taken to be added to lignocellulosic material in any one or more of steps a, b, c, d, e or g of the previous (upstream) stage, but fresh solvent is added in any one or more of steps a, b, c, d, e or g of the final stage, for example in step a of the final stage to the lignocellulosic material coming from the previous stage or in step b or c directly to the extractor used in the final stage. Finally extracted lignocellulosic material leaves the final stage, which may or may not be further processed. Lignocellulosic material and solvent are thus used in a countercurrent manner, that is fresh lignocellulosic material preferably enters the process in the first stage and is more and more extracted in each of the following stages until finally extracted in the final stage, and fresh solvent preferably enters the process in the final stage and is more and more enriched with extracted components from stage to stage in the opposite direction until it is finally removed as an extract from the first stage. In this manner, lignocellulosic material is gradually depleted of extractable components from the first to the final stage, whereas solvent is gradually enriched with extractable components in the opposite direction, i.e., from the final to the first stage. If only the liquid phases are considered, it can be said that the raffinate, i.e., the liquid phase of the treated lignocellulosic material (comprising solid and liquid phase) is gradually depleted of solutes from stage to stage in downstream direction, whereas solvent is gradually enriched in solutes from the raffinate from stage to stage in upstream direction.

In a multi-stage process according to the invention it is preferred that the lignocellulosic material conveyed in step a of the first stage to the extractor consists of hydrothermally pretreated, preferably autohydrolytically pretreated, lignocellulosic material, and that the solvent added to the lignocellulosic material in any one or more of steps a, b, c, d, e or g in the final stage consists of fresh solvent. In intermediate stages and the final stage, the lignocellulosic material to be treated is pressed lignocellulosic material from the respective previous (upstream) stage, and in the intermediate stages and the first stage the solvent added to the lignocellulosic material in any one or more of steps a, b, c, d, e or g is pressate from the respective following (downstream) stage.

In preferred embodiments of the two-stage or multi-stage embodiments of the process of the invention, in each stage the flow rate \dot{m}₄ with which the suspension is conveyed to the pressing device is greater than the sum of the flow rate \dot{m}₇ with which pressate is conveyed to the pressate tank and the flow rate \dot{m}₆ with which pressed lignocellulosic material is withdrawn from the pressing device, and excess suspension conveyed from the extractor to the pressing device is returned, preferably by gravity, from the pressing device to the extractor at a flow rate \dot{m}₅=\dot{m}₄−(\dot{m}₆+\dot{m}₇).

In a preferred embodiment of a multi-stage process of the invention, the flow rate 19 of solvent added in each of the intermediate stages and originating from the following (downstream) intermediate or final stage is equal to the flow rate 19 of the pressate withdrawn as an extract from this intermediate stage. The flow rate 19 of solvent withdrawn from the first stage may be different from the flow rate 19 of solvent transferred from the subsequent intermediate (second) stage, depending on the initial moisture of the lignocellulosic material. The flow rate \dot{m}₂ of added solvent is, for example, adapted to counterbalance the removal of “free” liquid phase (not bound to a solid, like raffinate) removed from the process of the invention, and may or may not, depending on the presence or absence of a difference in moisture content of the lignocellulosic material entering the first stage and leaving the final stage, be equal to the flow rate 19 of the pressate withdrawn as an extract in the first stage. In an embodiment, where the moisture content of the lignocellulosic material entering the first stage is essentially the same as the moisture content of the lignocellulosic material leaving the final stage, the flow rate \dot{m}₉ of the pressate withdrawn as an extract in the first stage can essentially be equal to the flow rate \dot{m}₂ of fresh solvent added in the final stage. If \dot{m}_{1L} denotes the flow rate of the liquid phase of the lignocellulosic material entering the first stage, and \dot{m}_{6L} denotes the flow rate of the liquid phase of the lignocellulosic material leaving the final stage, the flow rate \dot{m}₂ is preferably equal to \dot{m}₉+(\dot{m}_{6L}−\dot{m}_{1L}). If \dot{m}_{6L}=\dot{m}_{1L} the flow rate \dot{m}₂ equals the flow rate \dot{m}₉.

In a further preferred embodiment of a multi-stage process of the invention, all of the extraction stages, i.e., from the first to the final stage, are interposed between the two steps of a two-step hydrothermal pretreatment, preferably a two-step autohydrolysis pretreatment. In this embodiment, the lignocellulosic material is hydrothermally pretreated before the first extraction stage and also after the final extraction stage. It is also possible to additionally place the process of the invention, in the form of a single-stage, two-stage or multi-stage process, before the first and/or after the second hydrothermal pretreatment step, e.g., in the following order: Process of the invention—first hydrothermal pretreatment step—process of the invention—second hydrothermal pretreatment step—process of the invention.

The invention also relates to an apparatus for continuous extraction of lignocellulosic material according to the process of the invention described above. The apparatus may also be referred to as a “plant” or “system”. The apparatus of the invention comprises at least one apparatus module, the module comprising a conveyer, extractor, pressate tank and pressing device, the conveyer, extractor, pressate tank and pressing device each being configured, arranged and interconnected in a manner to being able to carry out the process of the invention. A “conveyor” is any means being able to convey lignocellulosic material to the extractor, e.g., a belt or screw conveyor.

The apparatus for continuous extraction of lignocellulosic material according to the process of the invention comprises at least one module comprising a conveyer, an extractor, a pressate tank and a pressing device, wherein, in the direction of flow of the lignocellulosic material the extractor is arranged downstream of the conveyer, the pressing device is arranged downstream of the extractor, and the pressate tank is arranged downstream of the pressing device, and wherein the pressate tank and the extractor are, directly or indirectly via a pump, in fluid communication with each other, such that pressate can be conveyed from the pressate tank to the extractor.

In a preferred embodiment of the apparatus of the invention the pressate tank is arranged higher in relation to the extractor in order to allow the first part of the pressate to be returned from the pressate tank to the extractor by gravity. In a further preferred embodiment, the pressing device is additionally or alternatively arranged higher in relation to the extractor in order to allow part of the suspension being returned from the pressing device to the extractor by gravity.

In a preferred embodiment of the apparatus of the invention, the extractor is an agitator vessel and the pressing device is a screw separator.

In a particular preferred embodiment of the apparatus of the invention, the apparatus is configured to carry out a multi-stage process according to the invention, preferably a countercurrent process as described above. In this embodiment, the apparatus comprises two or more of the modules described above connected in series. Each of the modules comprises a conveyer, an extractor, a pressate tank and a pressing device, wherein, in the direction of flow of the lignocellulosic material the extractor is arranged downstream of the conveyer, the pressing device is arranged downstream of the extractor, and the pressate tank is arranged downstream of the pressing device, and wherein the pressate tank and the extractor are, directly or indirectly via a pump, in fluid communication with each other, such that pressate can be conveyed from the pressate tank to the extractor. Preferably, the modules are interconnected in a manner that a countercurrent flow of lignocellulosic material and solvent can be realized, as described above.

The modules are, for example, arranged and interconnected in a manner that a first module carries out a first stage of the process of the invention, one or more modules each carry out an intermediate stage of the process of the invention, and a final module carries out a final stage of the process of the invention, as described above.

In a further preferred embodiment of a “multi-module” apparatus of the invention, i.e., an apparatus of the invention comprising two or more modules, the pressing devices of each module are arranged higher than the conveyors of the following module, such that pressed lignocellulosic material can be conveyed from the pressing device to the conveyor of the following module by gravity.

In the following, the invention will be described in further detail by way of example only with reference to the accompanying figures.

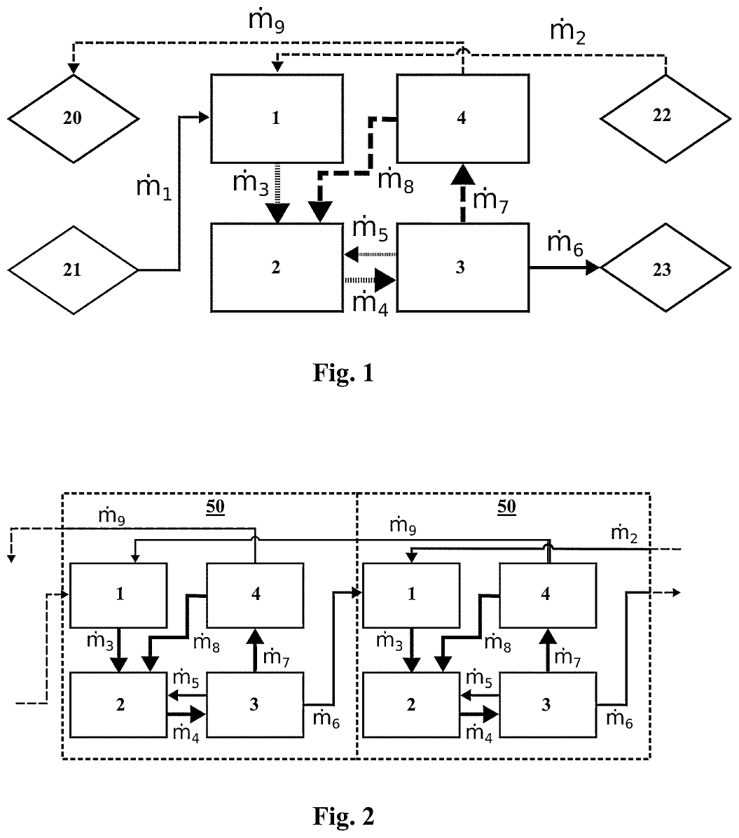

FIG. 1. Schematic flow diagram of an embodiment of the process of the invention.

FIG. 2. Schematic flow diagram of a further embodiment of the process of the invention.

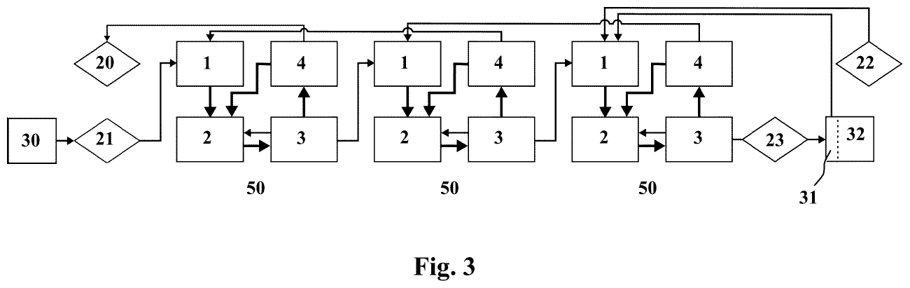

FIG. 3. Schematic flow diagram of a preferred embodiment of the process of the invention.

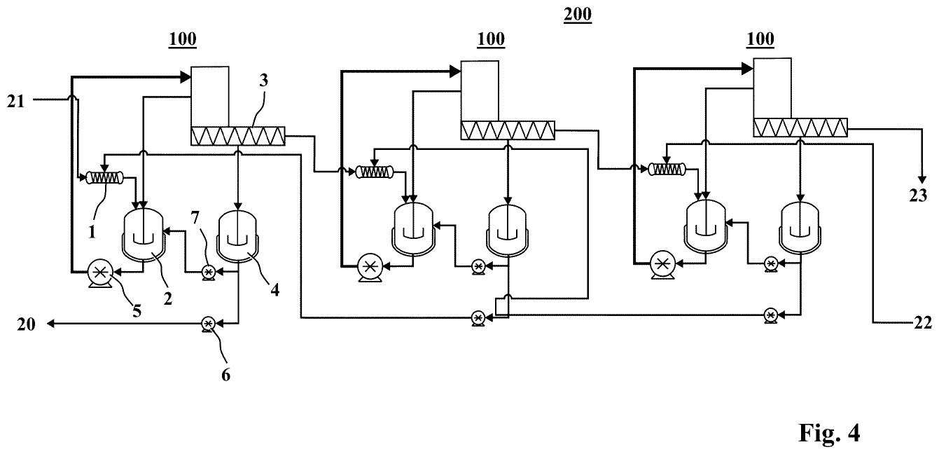

FIG. 4. Simplified system scheme of an embodiment of an apparatus for carrying out an embodiment of a multi-stage process of the invention.

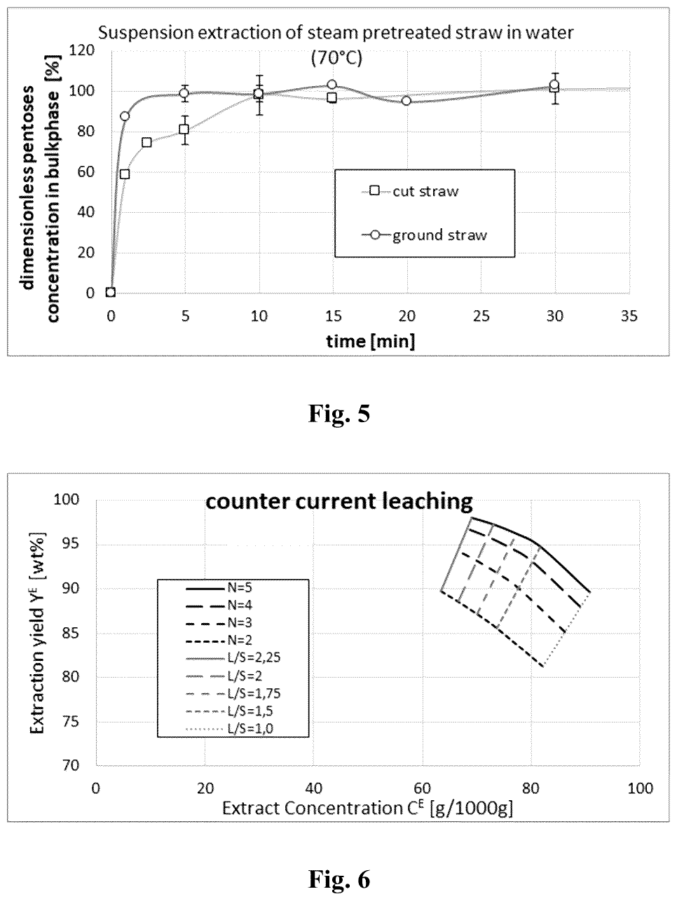

FIG. 5. Experimental data for the suspension extraction of a steam pretreated (180° C., 35 minutes) wheat straw (cut straw and ground straw) in water in a stirred tank. Shown is the dimensionless concentration of total pentoses.

FIG. 6. Process window for a continuous suspension extraction process configured as a countercurrent leaching process. N=number of stages; L/S=solvent usage (liquid-solid ratio).

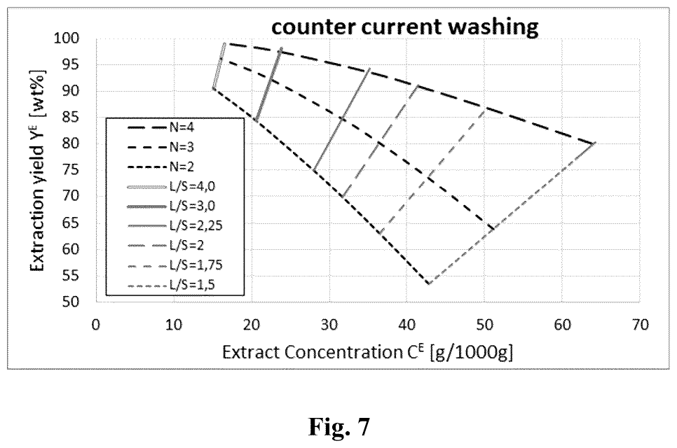

FIG. 7. Process window for a continuous suspension extraction process configured as a countercurrent washing process. N=number of stages; L/S=solvent usage (liquid-solid ratio).

FIG. 1 shows a flow diagram of a basic embodiment of the process of the invention, configured as a one-stage process. Relevant mass flows are given with arrows and mass flow rates with the symbol m and an index i. For the sake of simplicity, the different streams will also be referred to by the indexed symbol \dot{m}. Dashed arrows represent streams of liquid, striped arrows (see streams between conveyer 1 and extractor 2, and between extractor 2 and pressing device 3) represent streams of slurry and solid arrows represent streams of solids. It should be noted here that the terms “liquid”, “slurry” and “solid” are not preclusive, and should thus not be construed as meaning that e.g., a liquid stream does not contain any solids and a solids stream does not contain a liquid. A liquid stream can also contain solids, for example fine particles. The term “solid stream” relates to a stream of lignocellulosic material not being suspended in solvent, the term “slurry” to a stream composed of liquid and solids, the term “liquid” to a stream mainly composed of liquid. The term “solid stream” in relation to a lignocellulosic material encompasses the solids of the lignocellulosic material and moisture bound to it. All streams may contain solutes. A mass flow of fresh, i.e., not yet extracted, lignocellulosic material 21, for example a particulate hydrothermally pretreated biomass material, is put onto or into a conveyor 1 at a flow rate mi, the conveyor 1 conveying the lignocellulosic material 21 and added solvent 22, if added to the lignocellulosic material 21 in this step, at a mass flow rate \dot{m}₃ to an extractor 2. In the extractor 2, which may be configured as an agitator vessel, e.g., a stirred vessel, the lignocellulosic material 21 is contacted and mixed with solvent 22, preferably hot water of, for example 60° C., in order to form a mixture of lignocellulosic material 21 suspended in the solvent 22 and to extract solutes, namely valuable substances or contaminants, from the lignocellulosic material 21. The suspension is preferably agitated in the extractor 2 in a suitable manner and over a sufficient time period in order to facilitate extraction of solutes from the lignocellulosic material 21. From the extractor 2, suspension is withdrawn at a flow rate \dot{m}₄ and conveyed to the pressing device 3, preferably a screw separator. Pressate generated in the pressing device 3 is conveyed, e.g., by gravity or via a pump, at a flow rate \dot{m}₇ to a pressate tank 4, from which a first part is returned back into the extractor 2 at a flow rate \dot{m}₈ and a second part withdrawn as an extract 20 at a flow rate \dot{m}₉ flow. The extract 20 is finally removed from the system or, in case of a multi-stage process, returned back into the system, i.e., to a previous (upstream) stage (see, for example, FIG. 2 below). Pressed (extracted) lignocellulosic material 23 is withdrawn from the pressing device and finally removed from the system, e.g., for further processing or as a waste product. Fresh solvent 22 is added at a flow rate \dot{m}₂ to the lignocellulosic material 21 when conveyed to the extractor 2.

In a preferred embodiment, the mass flow \dot{m}₄ from the extractor 2 to the pressing device 3 exceeds the sum of the pressate stream \dot{m}₇ and the raffinate stream \dot{m}₆, such that \dot{m}₄>(\dot{m}₆+\dot{m}₇), and excess suspension from the extractor 2 is returned from the pressing device 3 to the extractor 2 at a flow rate \dot{m}₅, for example in that the pressing device 3 overflows and overflowing suspension is returned to the extractor 2 by gravity as a mass stream with flow rate \dot{m}₅.

It should be noted here that, in case of a multi-stage process, FIG. 1 would also be applicable to the last stage of the multi-stage process, with the proviso that the reference numeral 21 in the left-hand part of the figure would have to be replaced with reference numeral 23 denoting pressed lignocellulosic material 21 being at least once extracted by the method schematically shown in FIG. 1 above.
or, in case of a multi-stage process, returned back into the system, i.e., to a previous (upstream) stage (see, for example, FIG. 2 below)

FIG. 2 schematically shows part of an embodiment of a multi-stage process according to the invention, one of the stages being a final stage. Two stages 50 connected in series are shown here as an example. The stages 50 are framed by dashed rectangles for clarity. Mass streams m are not differentiated here according to the type of material (liquid, solid, or slurry). In both stages 50, in principle, the process steps described above are carried out, i.e., lignocellulosic material 21, 23 is fed into and extracted in an extractor 2, then fed into a pressing device 3, from which pressed extracted lignocellulosic material 23 is withdrawn. Pressate is conveyed to a pressate tank 4, from which a first part of the pressate is returned to the extractor 2, and a second part of the pressate is withdrawn from the pressate tank 4. Further, part of the suspension conveyed from the extractor 2 to the pressing device 3 is returned to the extractor. From FIG. 2 it can be seen more clearly that, in a multi-stage process, the second pressate stream \dot{m}₉ withdrawn from the pressate tank 4 is returned to the previous stage and added, depending on the kind of upstream stage (intermediate stage or first stage) to either fresh lignocellulosic material 21 (in a first stage) or pressed lignocellulosic material 23 (in an intermediate stage) when conveyed to the extractor 2 or directly to the extractor 2. The stage 50 shown on the right of FIG. 2 is configured as a final stage 50 and fresh solvent 22 is added here to the conveyor 1 at a mass flow rate \dot{m}₂. Pressed lignocellulosic material 23 from the previous stage 50 (left) is fed into the final stage (right). The stage 50 shown on the left side of FIG. 2 is an intermediate stage 50. From this stage, the second part of pressate withdrawn from the pressate tank 4 is conveyed to the conveyor 1 or extractor 2 of the previous (upstream) stage 50 (indicated only by dashed lines). The previous stage 50 may be a further intermediate stage 50 or a first stage 50. Pressed lignocellulosic material 23 is conveyed from the pressing device 3 to the next (downstream) stage 50.

FIG. 3 shows a flow chart of a preferred embodiment of the process of the invention. The process shown here schematically is a multi-stage process having three stages 50, a first stage (left), an intermediate stage 50 (middle) and a final stage 50 (right). Lignocellulosic material 21, preferably particulate hydrothermally pretreated biomass, for example hydrothermally pretreated wheat straw particles, is continuously fed into an extractor 2 of the first stage 50 of the process. The lignocellulosic material 21, 23 is treated in each stage 50 as described above. Pressed (extracted) lignocellulosic material 23 from the first stage 50 enters the second (intermediate) stage 50 and serves as a starting material there, is then treated in the intermediate stage 50 as described and leaves the intermediate stage 50 in a further extracted state as a pressed lignocellulosic material 23 in order to serve as starting material for the final stage 50, where it is again treated with the steps described above. It is thus transported from stage 50 stage 50 (from left to right in FIG. 3) and leaves the final stage 50 as a finally extracted lignocellulosic material 23. In contrast, the solvent 22 for the extraction of the lignocellulosic material 21, 23 enters the process in the final stage 50 and is, compared to the lignocellulosic material 21, 23, transported from stage 50 to stage 50 in the opposite direction, i.e., from the final stage 50 to the first stage 50 (from right to left in FIG. 3) and is removed from the process as an extract 20 produced in the first stage 50. The solvent is thus gradually enriched with substances extractable from the lignocellulosic material 21, 23 from stage 50 to stage 50. This countercurrent process allows for an efficient extraction of the lignocellulosic material 21, 23 since the concentration differences of the extractants in the solvent are kept at a favorable level. Lignocellulosic material 23 that is already largely depleted is extracted with fresh solvent in order to allow for a further extraction of the biomass, and fresh lignocellulosic material 21 is extracted with solvent that is already enriched with extractable substances but still able to extract substance from the fresh material.

In this embodiment, the process of the invention is combined with a two-step hydrothermal treatment (Ruiz, H. A., Conrad, M., Sun, S., Sanchez, A., Rocha, G., Romani, A., Castro, E., Torres, A., Rodriguez-Jasso, R. M., Andrade, L. P., Smirnova, I., Sun, R., & Meyer, A. (2019), Engineering aspects of hydrothermal pretreatment: From batch to continuous operation, scale-up and pilot reactor under biorefinery concept, Bioresource technology, 122685, doi: 10.1016/j.biortech.2019.122685; Conrad, M. and Smirnova, I. (2020), Two-Step Autohydrolysis Pretreatment: Towards High Selective Full Fractionation of Wheat Straw, Chemie Ingenieur Technik, 92: 1723-1732, doi:10.1002/cite.202000056). A three-stage extraction process as described above is interposed between the first and the second step of the two-step hydrothermal treatment. For this purpose, a first screw conveyor reactor (SCR) 30 is used to hydrothermally pretreat the lignocellulosic material 21, e.g., particulate biomass like grain straw. The lignocellulosic material 21 pretreated in this manner is a moist and sponge-like material that is very suitable for the subsequent extraction. After extraction, be it in a single or multi-stage process according to the invention, the extracted lignocellulosic material 23 leaving the final stage is treated with a second hydrothermal treatment step. In the embodiment illustrated here, a high-pressure screw feeder (HP screw) 31 being part of a second screw conveyor reactor (SCR) 32 is used to drain the lignocellulosic material 23 leaving the final stage 50 of the extraction process and to feed the lignocellulosic material 23 into a reaction vessel of the second SCR 32. The high-pressure screw feeder (HP screw) compresses and mechanically drains (for example to about 40-55% moisture content) the moist biomass to a vapor-tight plug. Liquid pressed-off in this step can be returned to the final stage 50 of the upstream extraction stage 50, as shown in FIG. 3. The combination of the extraction process and the two autohydrolysis steps improves the overall balance of the extraction, since more solutes are transferred to the liquid phase (raffinate) of the lignocellulosic material, the solids are finally in drier state and the valuable substances in the moisture are not lost, but are transferred to the extract.

FIG. 4 depicts a simplified system scheme of an apparatus 200 of the invention, configured for carrying out a multi-stage process as described in FIG. 3. Components for hydrothermal pretreatment of lignocellulosic material 21, 23 are not shown here. The apparatus 200 shown comprises three modules 100 connected in series, each module 100 being configured for carrying out a single stage 50 of the process. Each module comprises a conveyor 1, an extractor 2, a pressing device 3 and a pressate tank 4. In the embodiment of the apparatus 200 of the invention shown, the extractor 2 and pressate tank 4 of each module 100 are configured as stirred vessels. The pressing device 3 is configured as a screw separator. The suspension of fresh lignocellulosic material 21 or pressed lignocellulosic material 23 and solvent 22 is conveyed to the pressing device 3 by means of a suitable pump 5, pressate is conveyed by means of pumps 6, 7, the latter conveying pressate back to the extractor 2 of the same module 100, the former conveying pressate to the conveyor 1 of the previous module 100 or withdrawing pressate from the apparatus 200. It is, of course, also possible to only use a single pump for both pressate streams together with suitable control valves. The pressing device 3 is placed higher than the pressate tank 4 and the extractor 2 in order to allow pressate and excess suspension to be returned by gravity to the pressate tank 4 and extractor 2 respectively.

### EXAMPLES

A suspension extraction of large and small particles (1-2 cm and 1-2 mm in length, respectively) of cut and cut and ground, respectively, wheat straw pretreated at 180° C. for 35 minutes, which were not further crushed or pressed, was carried out according to the process of the invention. A large gradient was set in terms of the concentration of valuable substances in the wheat straw and the solvent, which ensures that more valuable material has to be transported until an equilibrium is reached. The material transport here includes the transport of liquid into the particles, mixing with the existing moisture with valuable substances in the particles, diffusion of the valuable substances through the spongy structure to the particle surface (long transport path for large particles) and transport from the particle surface into the bulk phase.

For this purpose, 3000 mL water at 70° C. was placed in a stirred 10 L vessel and the pretreated wheat straw was added at time t=0. The solids loading in the suspension was 2%. The mixture was sampled at various test times and separated into solid and liquid phases with a syringe filter. The concentration of the liquid samples was examined for the composition of carbohydrates in monomeric and oligomeric form. To compensate the minor effect of different feed moisture and concentrations the total pentose sugar concentrations are reported normalized to a range of 0%, before pretreated straw addition to 100%, final concentration, which is stable in at least three measurements. The normalized concentration courses over time of total pentose sugars in the extract are depicted in FIG. 5.

The experimental and reported data can be found in Tables 1, 2 and 3 below.

TABLE 1
Experimental data of batch suspensions
extraction of cut pretreated wheat straw.
cut straw

| | #1 | #2 | dimensionless | | | |
|---|---|---|---|---|---|---|
| t | Pen tot | Pen tot | Mean | St. Dev | Mean | St. Dev |
| [min] | [g/L] | [g/L] | [g/L] | [g/L] | [%] | [%] |
| 0 | 0 | 0 | 0 | 0 | 0 | 0 |
| 1 | 1.18 | | 1.18 | 0 | 58 | 0 |
| 2.5 | 1.46 | 1.53 | 1.49 | 0.036 | 74 | 2 |
| 5 | 1.48 | 1.76 | 1.62 | 0.139 | 80 | 7 |
| 10 | 1.78 | 2.16 | 1.97 | 0.192 | 98 | 10 |
| 15 | 1.90 | 1.97 | 1.94 | 0.038 | 96 | 2 |
| 30 | 1.88 | 2.18 | 2.03 | 0.149 | 101 | 7 |
| 60 | 1.95 | 2.18 | 2.06 | 0.113 | 103 | 6 |
| | 2.01 | average in eq. | | | | |

t = time, Pen tot = total pentose sugar, St. Dev = standard deviation.

TABLE 2
Experimental data of batch suspensions
extraction of ground pretreated wheat straw.
ground straw

| | #1 | #2 | dimensionless | | | |
|---|---|---|---|---|---|---|
| t | Pen tot | Pen tot | Mean | St. Dev | Mean | St. Dev |
| [min] | [g/L] | [g/L] | [g/L] | [g/L] | [%] | [%] |
| 0 | 0.00 | 0.00 | 0.00 | 0 | 0 | 0 |
| 1 | | 1.10 | 1.10 | 0 | 87 | 0 |
| 5 | 1.20 | 1.30 | 1.25 | 0.05 | 99 | 4 |
| 10 | 1.20 | 1.30 | 1.25 | 0.05 | 99 | 4 |
| 15 | 1.30 | | 1.30 | 0 | 103 | 0 |
| 20 | 1.20 | | 1.20 | 0 | 95 | 0 |
| 30 | | 1.30 | 1.30 | 0 | 103 | 0 |
| | 1.27 | | average in eq. | | | |

t = time, Pen tot = total pentose sugar, St. Dev = standard deviation.

TABLE 3
Experimental conditions.

| | Ground | Cut |
|---|---|---|
| | straw | straw |
| DM-before, ext. | 0.29 | 0.31 |
| Tank | 10 L | 10 L |
| M_water,0 | 3 L | 3 L |
| DM-tank | 2.00 | 2.01 |
| M_wet [g] | 221.71 | 208.01 |
| C_pen-final | 1.30 | 2.03 |
| [g/L] | | |

DM-before, ext = Dry matter content of pretreated wheat straw, M_water = water mass bevor addition of solid material, M_wet = wet biomass added, C_pen-final = Total pentose sugar concentration when finishing the experiment.

For the large, cut, particles, it can be seen that after 10 minutes the concentration of total pentose sugar is constant and the transport of substances is thus complete. The pentose sugar shown are 90% in oligomeric form. Thus, a faster transport is expected for smaller molecules. For the small, cut and ground, particles, it can be seen, that after one minute more than 80% of the equilibrium concentration is reached. After five minutes the equilibrium concentration is reached. It is expected, that for smaller molecules than the present oligomers a shorter equilibration time is likely.

Concluding, the small particles of the pretreated wheat straw, as they are expected after a continuous autohydrolysis pretreatment, show an adequate low equilibration time for the continuous suspension extraction process of the invention. For larger straw particles the equilibration time is expected to be shorter in washing processes, where contaminates are either smaller molecules than oligomer pentoses or are to be found on the particle surface instead, and not the interior, like dust or manure.

The characteristics of a washing and a leaching process of the invention were calculated for a specific substrate (wheat straw) as an example. The aim of the calculation is to calculate the process windows indicating the number of stages (N) and the use of solvent (L/S) for a given feed, a desired extract concentration and recovery of valuable substances. In this example, a feed from the steam digestion (autohydrolysis) with wheat straw is taken with the following mass percentages: 25.8% dry biomass, 66.7% water, 7.5% dissolved valuable substances for the leaching process and 86.4% dry biomass, 9.1% water, 4.5% dissolved valuable substances for the washing process. The following assumptions were made: In each stage, an equilibrium is established between the intra- and extra-particulate concentrations of valuable substances; the press screws dewater the solids to a dry matter of 33%; the last screw (high pressure feeder) dehydrates the solids to a dry substance of 50%. The result was calculated for 2-5 stages and a solvent use between 1.0-4.0 kg water per kg dry biomass. FIGS. 6 and 7 show the resulting process windows. This clearly shows that a high extraction yield and high extract concentration can be reached simultaneously with the process of invention, using a very small amount of solvent for both investigated applications. The performance of the process can be flexibly tailored to the biorefinery needs by selection of the design parameters (number of stages, solvent consumption).

1. A process for continuous extraction of lignocellulosic material, the process comprising at least one stage comprising the steps of
a) conveying the lignocellulosic material into an extractor,
b) forming, in the extractor, a suspension of the lignocellulosic material and a solvent, c) extracting the lignocellulosic material in the extractor with the solvent,
d) withdrawing part of the suspension from the extractor and conveying it to a pressing device at a flow rate \dot{m}₄,
e) separating the solvent from the lignocellulosic material by pressing off the solvent from the lignocellulosic material in the pressing device and conveying pressed-off solvent as a pressate to a pressate tank at a flow rate \dot{m}₇,
f) withdrawing pressed lignocellulosic material from the pressing device at a flow rate \dot{m}₆,
g) returning a first part of the pressate from the pressate tank at a flow rate \dot{m}₈ into the extractor,
h) withdrawing a second part of the pressate as an extract from the pressate tank at a flow rate \dot{m}₉,
i) Adding solvent to the lignocellulosic material in any one or more of steps a, b, c, d, e or g at a flow rate \dot{m}₂.

2. The process according to claim 1, wherein, in step d, the flow rate \dot{m}₄ with which the suspension is conveyed to the pressing device is greater than the sum of the flow rate \dot{m}₇ with which pressate is conveyed to the pressate tank and the flow rate \dot{m}₆ with which pressed lignocellulosic material is withdrawn from the pressing device, and wherein part of the suspension conveyed from the extractor to the pressing device is returned from the pressing device to the extractor at a flow rate \dot{m}₅=\dot{m}₄−(\dot{m}₆+\dot{m}₇).

3. The process according to claim 2, wherein part of the suspension is returned from the pressing device to the extractor by gravity and/or wherein the first part of the pressate is returned from the pressate tank to the extractor by gravity.

4. The process according to one of the preceding claims, wherein, in step a, the lignocellulosic material is conveyed into the extractor by means of a conveyor.

5. The process according to one of the preceding claims, wherein the flow rate \dot{m}₈ of pressate returned to the extractor is greater than the flow rate \dot{m}₉ of pressate withdrawn as an extract.

6. The process according to one of the preceding claims, wherein the solvent is added to the lignocellulosic material in step a when conveyed into the extractor and/or is added directly into the extractor in one of steps b or c.

7. The process according to one of the preceding claims, wherein the pressing device is a screw separator.

8. The process according to one of the preceding claims, wherein the extractor is an agitator vessel.

9. The process according to one of the preceding claims, wherein the solvent is water.

10. The process according to one of the preceding claims, wherein the lignocellulosic material is in the form of particles.

11. The process according to one of the preceding claims, wherein the lignocellulosic material is a hydrothermally pretreated lignocellulosic material, particularly preferred autohydrolytically pretreated lignocellulosic material.

12. The process according to one of the preceding claims, wherein the process is a multi-stage process comprising at least two stages, a final stage comprising the steps a to i above, and at least one upstream stage comprising the steps a to h above and a step i of adding solvent to the lignocellulosic material in any one or more of steps a, b, c, d, e or g at a flow rate 19, wherein the solvent added to the lignocellulosic material in the final stage is fresh solvent, and wherein the solvent added to the lignocellulosic material in the upstream stage comprises or consists of the second part of the pressate from the pressate tank.

13. The process according to claim 12, comprising a first stage, a final stage and one or more intermediate stages between the first and final stage, wherein, in any of the intermediate stages the solvent added to the lignocellulosic material comprises or consists of the second part of the pressate withdrawn from the pressate tank in step h of the following stage, and the lignocellulosic material conveyed into the extractor consists of the pressed lignocellulosic material withdrawn from the pressing device in step f of the previous stage.

14. The process according to claim 13, wherein the lignocellulosic material conveyed in step a of the first stage to the extractor consists of hydrothermally pretreated lignocellulosic material, preferably in the form of particles, and wherein the solvent added to the lignocellulosic material in the final stage consists of fresh solvent.

15. The process according to one of claims 12 to 14, wherein the flow rate \dot{m}₂ of solvent added is equal to the flow rate \dot{m}₉ of the pressate withdrawn as an extract in each of the stages except the first stage or the first and the final stage.

16. The process according to one of the preceding claims, wherein the pressed lignocellulosic material withdrawn from the pressing device is subjected to a subsequent hydrothermal treatment, preferably an autohydrolytical treatment, in case of a multi-stage process preferably after the final stage.

17. An apparatus (200) for continuous extraction of lignocellulosic material according to the process of one of the preceding claims, comprising at least one module (100) comprising a conveyer (1), an extractor (2), a pressate tank (4) and a pressing device (3), wherein, in the direction of flow of the lignocellulosic material the extractor (2) is arranged downstream of the conveyer (1), the pressing device (3) is arranged downstream of the extractor (2), and the pressate tank (4) is arranged downstream of the pressing device (3), and wherein the pressate tank (4) and the extractor (2) are, directly or indirectly via a pump, in fluid communication with each other, such that pressate can be conveyed from the pressate tank (4) to the extractor (2).

18. The apparatus (200) according to claim 17, wherein the pressate tank (4) is arranged higher in relation to the extractor (2), and/or wherein the pressing device (3) is arranged higher in relation to the extractor (2).

19. The apparatus (200) according to one of claims 17 or 18, wherein the apparatus (200) comprises two or more of the modules (100) connected in series.

20. The apparatus according to one of claims 17 to 19, wherein the extractor (2) is an agitator vessel and the pressing device (3) is a screw separator.
